(19) United States
(12) Patent Application Publication
(10) Pub. No.: US 2011/0217502 A1
(43) Pub. Date: Sep. 8, 2011

(54) ANIONIC MODIFIED POLYURETHANE DISPERSIONS

(75) Inventors: Harald Kraus, Leverkusen (DE); Wolfgang Arndt, Dormagen (DE); Wolfgang Henning, Untermaubach (DE); Thomas Münzmay, (US); Alice Münzmay, Dormagen (DE)

(73) Assignee: Bayer Material Science AG, Leverkusen (DE)

(21) Appl. No.: 13/127,874

(22) PCT Filed: Oct. 31, 2009
(86) PCT No.: PCT/EP2009/007804

§ 371 Date: May 5, 2011

(30) Foreign Application Priority Data
Nov. 14, 2008 (EP) 08019883.1

(51) Int. Cl. B32B 27/06; C09J 175/08; B32B 27/00; B32B 27/40

(52) U.S. Cl. 428/64.1; 524/839; 428/355 N; 428/423.1; 428/221; 428/425.1

(57) ABSTRACT

The present invention relates to an aqueous polyurethane urea dispersion comprising a polyurethane urea polymer comprising structural units of the formula (I)

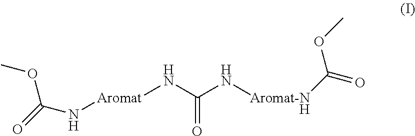

wherein Aromat represents a compound selected from the group consisting of phenylene, tolylene, xylylene, tetramethylxylylene and diphenylenemethane, and wherein the polyurethane urea is obtained from components comprising A) at least one aromatic diisocyanate, B) at least one polyether polyol having a number-average molecular weight of from 300 to 1500 Da, C) at least one compound having one to two isocyanate-reactive groups and at least one ionogenic group, D) at least one polyol having a number-average molecular weight of from 60 to 499 Da, and E) water, wherein the average overall functionality of compounds B) to D) is from 1.85 to 2.2 and wherein the sum of the amount of aromatic urea groups and the amount of urethane groups is 2700 to 5000 mmol per kg polyurethane urea polymer.

The invention relates to anionically modified polyurethane ureas based on aromatic polyisocyanates, a process for the production thereof and their use for the production of coatings of flat materials or for the production of adhesives.

One-pack polyurethane adhesives are gaining increasing importance in the wood bonding sector, since they have considerable advantages over the likewise frequently used polyvinyl acetate dispersions in terms of heat and water resistance. These polyurethane adhesives are generally NCO-terminated polyurethane prepolymers with significant NCO contents of between 5 and 20%. After being applied to wood, these react with its substrate humidity, or the humidity in the ambient air, to form a polyurethane-polyurea. Polyurethane systems based on polyether are generally preferred to those based on polyester as they are more resistant to humidity and microbes. Corresponding polyurethane adhesives are described e.g. in WO-A 03/066700.

One disadvantage of the use of polyurethane prepolymers as one-pack polyurethane adhesives can be seen in their high content of NCO groups, which make it necessary to exclude humidity when working on the formulation, processing and application of the adhesives. In addition, direct skin contact must be avoided by means of appropriate protective measures.

One solution can be provided by the use of aqueous polyurethane or polyurethane urea dispersions based on polyether. These are described in the prior art. For example, EP-A 0 615 988 describes the use of aqueous polyurethane dispersions containing a polyurethane having a very low urea group content as an adhesive.

The disadvantage of the polyurethane and polyurethane urea dispersions known from the prior art lies in the inadequate tensile shear strengths that can be achieved when they are used as one-pack adhesives for wood bonding.

The object of the present invention was therefore to provide polyurethane or polyurethane urea dispersions based on polyether which lead to improved tensile shear strengths when they are used as one-pack adhesives for wood bonding.

It has now been found that this object is achieved by the dispersions of polyurethane ureas made from aromatic diisocyanates according to the invention.

The present invention provides aqueous polyurethane urea dispersions containing a polyurethane urea polymer with structural units of the general formula (I)

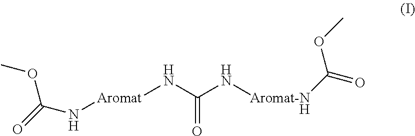

in which Aromat=phenylene, tolylene, xylylene, tetramethylxylylene or diphenylenemethane, preferably tolylene or diphenylenemethane, and which is made up of

A) one or more aromatic diisocyanates,

B) at least one polyether polyol having a number-average molecular weight of from 300 to 1500 Da, preferably from 500 to 1250 Da,

C) at least one compound having one to two isocyanate-reactive groups and at least one ionogenic group,

D) at least one polyol having a number-average molecular weight of from 60 to 499 Da, preferably 90 to 220 Da,

E) water,

wherein the average overall functionality of the isocyanate-reactive compounds B) to D) is from 1.85 to 2.2, preferably from 1.9 to 2.1, and in the polyurethane urea polymer the sum of the content of aromatic urea groups and the content of urethane groups is 2700 to 5000 mmol per kg, preferably 2800 to 4000 mmol per kg and particularly preferably 2850 to 3500 mmol per kg polyurethane urea polymer.

The following are mentioned as examples of diisocyanate component A): 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate and mixtures consisting of these compounds. 2,4-Diisocyanatotoluene, 2,6-diisocyanatotoluene, 4,4′-diisocyanatodiphenylmethane, 2,2′- and 2,4′-diisocyanatodiphenylmethane and mixtures consisting of these compounds are preferred. 2,4-Diisocyanatotoluene or 2,6-diisocyanatotoluene or mixtures thereof are particularly preferred.

As polyether polyols B), the polyaddition products of ethylene oxide, propylene oxide, butylene oxide and their co-polyaddition and graft polyaddition products, as well as the polyethers obtained by condensation of polyhydric alcohols or mixtures thereof and by alkoxylation of water, polyhydric alcohols, amines or amino alcohols, are used. Homo- and/or co-polyaddition compounds of ethylene oxide and/or propylene oxide having a molecular weight of less than 1500 Da, preferably of 500 to 1250 Da, are preferred. The average functionality of the polyether polyols is greater than 1.85, preferably from 1.92 to 3. Particularly preferred are bifunctional polyethers having a functionality of from 1.95 to 2.05.

The proportion of ethylene oxide in the co-polyaddition compounds of ethylene oxide and propylene oxide is 1 to 50%, preferably 1 to 30%, particularly preferably 5 to 20%.

In a particularly preferred embodiment of the present invention, the polyether polyol B) is a homo-polyaddition product of propylene oxide having a molecular weight of from 750 to 1250 Da and a functionality of from 1.95 to 2.05.

Smaller quantities of higher molecular weight polyhydroxyl components, which are known per se from polyurethane chemistry, e.g. from the classes of the polyester, polylactone or polycarbonate polyols, may optionally also be used.

Suitable as ionogenic compounds C) having one to two isocyanate-reactive groups and at least one ionogenic group are compounds such as e.g. hydroxy- and mercaptocarboxylic acids, aminocarboxylic acids such as glycine, alanine or 4-aminobutyric acid, di- and polyhydroxycarboxylic acids such as dimethylolpropionic acid or dimethylolbutyric acid or aliphatic diols containing sulfonate groups according to DE-A 2 446 440 (p. 4-p. 6) and 2 437 218 (pp. 3-4). The preferred ionogenic components C) include dimethylolbutyric or dimethylolpropionic acid.

In so far as ionogenic components C) are used in the form of non-neutralised carboxylic and/or sulfonic acids, tertiary amines such as triethylamine, tripropylamine, tributylamine, triisopropanolamine, triethanolamine, N,N-dimethylethanolamine or ammonia or alkali hydroxides such as sodium or potassium hydroxide or alkali carbonates or hydrogen carbonates are preferably suitable as neutralising agents.

As polyols D) it is possible to use compounds the molecular weight of which is greater than 60 Da, preferably between 90 and 220 Da, and which contain primary or secondary alcohol groups. Suitable as compounds D) are, for example, diols such as ethanediol, di-, tri-, tetraethylene glycol, 1,2-propanediol, di-, tri-, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof Other compounds that are suitable as component D) are polyol compounds having a hydroxyl functionality greater than 2, such as e.g. trimethylolpropane or glycerol. Particularly preferred as component D) are 1,4-butanediol, 1,3-butanediol, 2,3-butanediol, 1,5-pentanediol or 1,6-hexanediol.

The production of the aqueous polyurethane or polyurethane-urea dispersions according to the invention can take place in one or more steps in a homogeneous or a multi-step reaction, partly in the disperse phase. After polyaddition has been carried out in full or in part, a dispersing, emulsifying or dissolving step takes place. After this, a further polyaddition or modification optionally takes place in the disperse phase. All processes known from the prior art can be used for the production, such as emulsifier/shear force, acetone, prepolymer mixing, melt-emulsifying, ketimine and solid/spontaneous dispersion processes or derivatives thereof. The melt-emulsifying, prepolymer mixing and acetone processes are preferred. The prepolymer mixing process and the acetone process are particularly preferred and the acetone process is most particularly preferred.

The present invention also provides a process for the production of the aqueous polyurethane polyurea dispersions according to the invention, characterised in that the components A), B), C) and D) are initially charged into the reactor in full or in part in order to produce a polyurethane prepolymer and optionally diluted with a water-miscible solvent which is inert in respect of isocyanate groups, but preferably without solvents, and heated to temperatures in the range of from 50 to 120° C., preferably in the range of from 70 to 100° C., and then any components A), B), C) or D) which were not added at the beginning of the reaction are metered in and neutralisation takes place with a suitable neutralising agent before or during the dispersing and then the optionally used organic solvent is distilled off.

Suitable solvents are e.g. acetone, butanone, tetrahydrofuran, dioxane, acetonitrile, dipropylene glycol dimethyl ether or 1-methyl-2-pyrrolidone, which can be added not only at the beginning of production but optionally also later in portions. Acetone and butanone are preferred. It is possible to conduct the reaction under standard pressure or increased pressure.

To produce the prepolymer, the quantities of the individual components A) to D) used are calculated such that an isocyanate index of from 1.05 to 3.0, preferably from 1.1 to 1.8, results. The isocyanate content of the prepolymers is between 1.0 and 9.0%, preferably between 1.3 and 7.0%, particularly preferably between 1.5 and 6.0%.

10 to 60 parts by weight, preferably 20 to 40 parts by weight, of component A), 40 to 80 parts by weight, preferably 50 to 70 parts by weight, of component B), 1 to 20 parts by weight, preferably 3 to 12 parts by weight, of component C) and 0.5 to 20 parts by weight, preferably 1 to 10 parts by weight, of component D) are used, with the proviso that the sum of the components is 100.

The reaction of the components A) with B), C) and D) takes place partially or completely, based on the total amount of isocyanate-reactive groups, but preferably completely. The degree of conversion is generally monitored by following the NCO content of the reaction mixture. For this purpose, it is possible to perform both spectroscopic measurements, e.g. infrared or near infrared spectra, determinations of the refractive index and chemical analyses, such as titrations of samples that have been taken.

To accelerate the isocyanate addition reaction, it is possible to use conventional catalysts such as are known to the person skilled in the art to accelerate the NCO—OH reaction. Examples are triethylamine, 1,4-diazabicyclo-[2.2.2]-octane, dibutyltin oxide, tin dioctoate or dibutyltin dilaurate, tin bis(2-ethylhexanoate) or other organometallic compounds.

To produce the polyurethane or polyurethane urea dispersion, either the prepolymer is added to the dispersing water directly or after dissolving in a suitable solvent, preferably acetone, optionally under a strong shear force, such as e.g. vigorous stirring, or conversely the dispersing water is stirred into the prepolymer.

In so far as components C) with ionogenic groups in the form of non-neutralised carboxylic and/or sulfonic acids are used, neutralisation takes place before or during dispersion using a suitable neutralising agent, preferably tertiary amines such as triethylamine, tripropylamine, tributylamine, triethanolamine, triisopropanolamine, ethyldiisopropylamine, N,N-dimethylethanolamine and alkali hydroxides, alkali carbonates and/or alkali hydrogen carbonates. The quantity is calculated such that the degree of neutralisation is preferably between 40 and 200%, particularly preferably between 50 and 100%.

During and/or after dispersion, the isocyanate groups still present react with water to form urea groups.

After dispersion, the optionally used organic solvent, e.g. acetone, is distilled off.

The dispersions have a solids content of 10 to 70 wt. %, preferably 25 to 50 wt. % and particularly preferably 30 to 40 wt. %.

In general, the quantities of starting components A) to D) in the process according to the invention are calculated so as to result in anionically modified polyurethane ureas with 50 to 750 mmol, preferably 200 to 600 mmol and particularly preferably from 250 to 550 mmol of anionic groups/kg polymer.

The invention provides the use of the polyurethane urea dispersions according to the invention for the production of coatings of flat materials or as an adhesive.

The present invention also provides adhesives containing the polyurethane urea dispersions according to the invention.

The adhesives containing the polyurethane urea dispersions according to the invention are suitable for bonding any substrates, such as e.g. paper, cardboard, wood, cork, textiles, metal, leather and polymer or mineral materials. The adhesives according to the invention are particularly suitable for bonding wood or cork.

The adhesives containing the polyurethane urea dispersions according to the invention are preferably applied to the substrates to be bonded by the wet bonding method. This means that the bonding is carried out without drying immediately after applying the adhesive. Until the adhesive sets, a mechanical fixing of the parts to be bonded is necessary. However, it is also possible to operate using the thermo-activation method. In this case, the dispersion is applied to the substrate and, after all the water has evaporated, the adhesive layer is activated by heating, e.g. with an infrared heater, and converted to an adhesive state.

This results in an adhesive composite comprising at least one substrate and an adhesive layer containing the polyurethane urea dispersions according to the invention. The adhesive composites produced in this way, after using the wet bonding method on wood, lead to a tensile shear strength greater than 4.4 N/mm, preferably >4.8 N/mm, particularly preferably >5.0 N/mm.

The present invention provides an adhesive composite made up of one or more substrate(s), which can be the same or different, and an adhesive layer containing the polyurethane urea dispersions according to the invention.

The adhesives containing the polyurethane urea dispersions according to the invention are also suitable for bonding substrates such as glass fibre cloth, carbon fibre cloth or mineral fibre cloth or mineral substrates. In this case, the glass fibre cloth, carbon fibre cloth or mineral fibre cloth composites are preferably bonded to a mineral surface. As a result, buildings or structures can be better protected from destruction by mechanical influences or vibrations, for example.

Adhesive composites made up of one or more substrates selected from the group of glass fibre, carbon fibre or mineral fibre cloths and an adhesive layer containing the polyurethane urea dispersions according to the invention as well as a mineral substrate are therefore also preferred.

Adhesive composites made up of two wood substrates and an adhesive layer containing the polyurethane urea dispersions according to the invention are preferred.

Adhesive composites made up of cork granules bonded with a polymer material, a cork disc and an adhesive layer containing the polyurethane urea dispersions according to the invention are also preferred.

### EXAMPLES

The percentages in the following examples refer to the weight in each case; parts are parts by weight.

The invention is explained in more detail below based on the examples. The tensile shear strengths after applying the wet bonding method can be determined by the following method:

### Determination of the Tensile Shear Strength After Applying the Wet Bonding Method:

The determination is carried out with a one-pack formulation (without a crosslinking agent).

### Test Material/Test Piece

Beech wood (planed)/beech wood (planed), dimensions: 40×20×5 mm

### Bonding and Measurement

The adhesive dispersion is applied on to both beech wood test pieces using a brush. The adherend surface is 10×20 mm. The two test pieces are placed one on top of the other and joined for 72 h at room temperature under 5 bar pressure.

The test pieces are then loaded at room temperature at an angle of 180° C. to the adhesive joint and pulled apart at a rate of 100 mm per minute. The force needed for this (=peel strength, tensile shear strength) is measured. The determination is performed five times and the average value is given.

### Materials Used:

Luphen® D259U (BASF AG, Ludwigshafen/D):

Polyether-based polyurethane dispersion based on a polypropylene oxide polyether, dimethylolpropionic acid and toluene diisocyanate with a low content of urea groups (<50 mmol/kg) and a solids content of approx. 40%.

Dispercoll® U XP 2643 (Bayer MaterialScience AG, Leverkusen/D):

Polyether-based polyurethane dispersion based on a polypropylene oxide polyether with an average molecular weight of 2000 g/mol, dimethylolpropionic acid, ethylenediamine and toluene diisocyanate. The solids content is approx. 40%.

### Example 1 (According to the Invention)

240 g (239.5 mmol) of a polypropylene oxide diol (OH value 112, average molecular weight 1000 g/mol) and 25.7 g (191.6 mmol) dimethylolpropionic acid are dewatered for 60 min at 100° C. and 50 mbar. 5.7 g 1,6-hexanediol (48.2 mmol) are then added and the mixture is homogenised for 15 min at 100° C. After cooling to 70° C., 121.7 g (699.4 mmol) of an 80:20 mixture of 2,4- and 2,6-toluene diisocyanate are stirred in and after 15 min the temperature is kept constant at 90° C. After 3 h an isocyanate content of 4.60% is reached. The mixture is diluted with 69 g acetone and salted with 12.6 g (124.5 mmol) triethylamine for 10 min at 50° C. The prepolymer mixture is then added to 750 g water while stirring vigorously and dispersed for one hour at 40° C. After removing the acetone by distillation, a fine particle dispersion is obtained with a solids content of 33%.

Content of aromatic urea groups of formula (I) per kg anionically modified polyurethane urea: 543 mmol

(Calculation: 440.2 mmol NCO corresponding to 220.1 mmol urea groups per 405.7 g solids)

Content of urethane groups per kg anionically modified polyurethane urea: 2363 mmol

(Calculation: 958.6 mmol per 405.7 g solids)

Sum: 2906 mmol aromatic urea groups and urethane groups per kg anionically modified polyurethane urea

The determination of the tensile shear strength after applying the wet bonding method gives a value of 6.7 N/mm².

### Example 2 (According to the Invention)

240 g (239.5 mmol) of a polypropylene oxide diol (OH value 112, average molecular weight 1000 g/mol) and 25.7 g (191.6 mmol) dimethylolpropionic acid are dewatered for 60 min at 100° C. and 50 mbar. 2.85 g 1,6-hexanediol (24.1 mmol) are then added and the mixture is homogenised for 15 min at 100° C. After cooling to 70° C., 121.7 g (699.4 mmol) of an 80:20 mixture of 2,4- and 2,6-toluene diisocyanate are stirred in and after 15 min the temperature is kept constant at 90° C. After 4 h an isocyanate content of 4.91% is reached. The mixture is diluted with 69 g acetone and salted for 10 min at 50° C. with 12.6 g (124.5 mmol) triethylamine. The prepolymer mixture is then added to 720 g water while stirring vigorously and dispersed for one hour at 40° C. After removing the acetone by distillation, a fine particle dispersion is obtained with a solids content of 34%.

Content of aromatic urea groups of formula (I) per kg anionically modified polyurethane urea: 606 mmol

(Calculation: 488.4 mmol NCO corresponding to 244.2 mmol urea groups per 402.85 g solids)

Content of urethane groups per kg anionically modified polyurethane urea: 2260 mmol

(Calculation: 910.4 mmol per 402.85 g solids)

Sum: 2866 mmol aromatic urea groups and urethane groups per kg anionically modified polyurethane urea

The determination of the tensile shear strength after applying the wet bonding method gives a value of 6.4 N/mm².

### Example 3 (According to the Invention)

240 g (239.5 mmol) of a polypropylene oxide diol (OH value 112, average molecular weight 1000 g/mol) and 25.7 g (191.6 mmol) dimethylolpropionic acid are dewatered for 60 min at 100° C. and 50 mbar. 11.4 g 1,6-hexanediol (96.5 mmol) are then added and the mixture is homogenised for 15 min at 100° C. After cooling to 70° C., 121.7 g (699.4 mmol) of an 80:20 mixture of 2,4- and 2,6-toluene diisocyanate are stirred in and after 15 min the temperature is kept constant at 90° C. After 5 h an isocyanate content of 3.41% is reached. The mixture is diluted with 70 g acetone and salted for 10 min at 50° C. with 12.6 g (124.5 mmol) triethylamine. The prepolymer mixture is then added to 740 g water while stirring vigorously and dispersed for one hour at 40° C. After removing the acetone by distillation, a fine particle dispersion is obtained with a solids content of 33%.

Content of aromatic urea groups of formula (I) per kg anionically modified polyurethane urea: 418 mmol

(Calculation: 343.6 mmol NCO corresponding to 171.8 mmol urea groups per 411.4 g solids)

Content of urethane groups per kg anionically modified polyurethane urea: 2565 mmol

(Calculation: 1055.2 mmol per 411.4 g solids)

Sum: 2983 mmol aromatic urea groups and urethane groups per kg anionically modified polyurethane urea

The determination of the tensile shear strength after applying the wet bonding method gives a value of 5.4 N/mm².

### Example 4 (According to the Invention)

240 g (239.5 mmol) of a polypropylene oxide diol (OH value 112, average molecular weight 1000 g/mol) and 25.7 g (191.6 mmol) dimethylolpropionic acid are dewatered for 60 min at 100° C. and 50 mbar. 22.8 g 1,6-hexanediol (192.9 mmol) are then added and the mixture is homogenised for 15 min at 100° C. After cooling to 70° C., 121.7 g (699.4 mmol) of an 80:20 mixture of 2,4- and 2,6-toluene diisocyanate are then stirred in and after 15 min the temperature is kept constant at 90° C. After 5 h an isocyanate content of 1.53% is reached. The mixture is diluted with 273 g acetone and salted for 10 min at 50° C. with 12.6 g (124.5 mmol) triethylamine. The prepolymer mixture is then added to 1100 g water while stirring vigorously and dispersed for one hour at 40° C. After removing the acetone by distillation, a fine particle dispersion is obtained with a solids content of 30%.

Content of aromatic urea groups of formula (I) per kg anionically modified polyurethane urea: 177 mmol

(Calculation: 150.0 mmol NCO corresponding to 75.0 mmol urea groups per 422.8 g solids)

Content of urethane groups per kg anionically modified polyurethane urea: 2954 mmol

(Calculation: 1248.8 mmol per 422.8 g solids)

Sum: 3131 mmol aromatic urea groups and urethane groups per kg anionically modified polyurethane urea

The determination of the tensile shear strength after applying the wet bonding method gives a value of 5.3 N/mm².

### Example 5 (According to the Invention)

240 g (239.5 mmol) of a polypropylene oxide diol (OH value 112, average molecular weight 1000 g/mol) and 25.7 g (191.6 mmol) dimethylolpropionic acid are dewatered for 60 min at 100° C. and 50 mbar. 5.7 g 1,6-hexanediol (48.2 mmol) and 1.16 g (8.6 mmol) trimethylolpropane are then added and the mixture is homogenised for 15 min at 100° C. After cooling to 70° C., 121.7 g (699.4 mmol) of an 80:20 mixture of 2,4- and 2,6-toluene diisocyanate are stirred in and after 15 min the temperature is kept constant at 90° C. After 3.5 h an isocyanate content of 4.30% is reached. The mixture is diluted with 70 g acetone and salted for 10 min at 50° C. with 12.6 g (124.5 mmol) triethylamine. The prepolymer mixture is then added to 730 g water while stirring vigorously and dispersed for one hour at 40° C. After removing the acetone by distillation, a fine particle dispersion is obtained with a solids content of 33%.

Content of aromatic urea groups of formula (I) per kg anionically modified polyurethane urea: 509 mmol

(Calculation: 414.4 mmol NCO corresponding to 207.2 mmol urea groups per 406.86 g solids)

Content of urethane groups per kg anionically modified polyurethane urea: 2419 mmol

(Calculation: 984.4 mmol per 406.86 g solids)

Sum: 2928 mmol aromatic urea groups and urethane groups per kg anionically modified polyurethane urea

The determination of the tensile shear strength after applying the wet bonding method gives a value of 5.3 N/mm².

### Example 6 (Comparative)

Instead of the polyurethane dispersion from Example 1, Luphen D259U is used. The determination of the tensile shear strength after applying the wet bonding method gives a value of 2.6 N/mm².

### Example 7 (Comparative)

Instead of the polyurethane dispersion from Example 1, Dispercoll U XP 2643 is used. The determination of the tensile shear strength after applying the wet bonding method gives a value of 2.6 N/mm².

### Example 8 (Comparative)

324 g (323.4 mmol) of a polypropylene oxide diol (OH value 112, average molecular weight 1000 g/mol) and 29.55 g (220.3 mmol) dimethylolpropionic acid are dewatered for 60 min at 100° C. and 50 mbar. 5.7 g 1,6-hexanediol (48.2 mmol) are then added and the mixture is homogenised for 15 min at 100° C. After cooling to 70° C., 121.7 g (699.4 mmol) of an 80:20 mixture of 2,4- and 2,6-toluene diisocyanate are stirred in and after 15 min the temperature is kept constant at 90° C. After 4 h an isocyanate content of 1.69% is reached. The mixture is diluted with 160 g acetone and salted for 10 min at 50° C. with 14.49 g (143.2 mmol) triethylamine. The prepolymer mixture is then added to 1050 g water while stirring vigorously and dispersed for one hour at 40° C. After removing the acetone by distillation, a fine particle dispersion is obtained with a solids content of 34%.

Content of aromatic urea groups of formula (I) per kg anionically modified polyurethane urea: 217 mmol

(Calculation: 215.0 mmol NCO corresponding to 107.5 mmol urea groups per 495.44 g solids)

Content of urethane groups per kg anionically modified polyurethane urea: 2389 mmol

(Calculation: 1183.8 mmol per 495.44 g solids)

Sum: 2606 mmol aromatic urea groups and urethane groups per kg anionically modified polyurethane urea

The determination of the tensile shear strength after applying the wet bonding method gives a value of 3.3 N/mm².

### Example 9 (Comparative)

288.3 g (287.8 mmol) of a polypropylene oxide diol (OH value 112, average molecular weight 1000 g/mol) and 25.7 g (191.6 mmol) dimethylolpropionic acid are dewatered for 60 min at 100° C. and 50 mbar. After cooling to 70° C., 121.7 g (699.4 mmol) of an 80:20 mixture of 2,4- and 2,6-toluene diisocyanate are stirred in and after 15 min the temperature is kept constant at 90° C. After 3 h an isocyanate content of 4.00% is reached. The mixture is diluted with 77 g acetone and salted for 10 min at 50° C. with 12.6 g (124.5 mmol) triethylamine. The prepolymer mixture is then added to 810 g water while stirring vigorously and dispersed for one hour at 40° C. After removing the acetone by distillation, a fine particle dispersion is obtained with a solids content of 33%.

Content of aromatic urea groups of formula (I) per kg anionically modified polyurethane urea: 491 mmol

(Calculation: 440.0 mmol NCO corresponding to 220.0 mmol urea groups per 448.3 g solids)

Content of urethane groups per kg anionically modified polyurethane urea: 2139 mmol

(Calculation: 958.8 mmol per 448.3 g solids)

Sum: 2630 mmol aromatic urea groups and urethane groups per kg anionically modified polyurethane urea

The determination of the tensile shear strength after applying the wet bonding method gives a value of 4.0 N/mm².

As can be seen from the examples, the polyether-based polyurethane and polyurethane urea dispersions according to the invention lead to significantly improved tensile shear strengths when used as one-pack adhesives for wood bonding. In examples 1) to 5) these are between 5.3 and 6.7 N/mm². The values found in the comparative examples 6) to 9) corresponding to the prior art, on the other hand, are only between 2.6 and 4.0 N/mm².

1-12. (canceled)

13. An aqueous polyurethane urea dispersion comprising a polyurethane urea polymer comprising structural units of the formula (I) 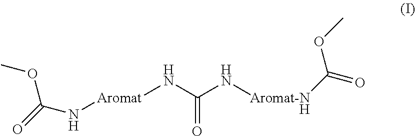
wherein Aromat represents a compound selected from the group consisting of phenylene, tolylene, xylylene, tetramethylxylylene and diphenylenemethane, and wherein the polyurethane urea is obtained from components comprising
A) at least one aromatic diisocyanate,
B) at least one polyether polyol having a number-average molecular weight of from 300 to 1500 Da,
C) at least one compound having one to two isocyanate-reactive groups and at least one ionogenic group,
D) at least one polyol having a number-average molecular weight of from 60 to 499 Da, and
E) water,
wherein the average overall functionality of compounds B) to D) is from 1.85 to 2.2 and wherein the sum of the amount of aromatic urea groups and the amount of urethane groups is 2700 to 5000 mmol per kg polyurethane urea polymer.

14. The aqueous polyurethane urea dispersion according to claim 13, wherein the average functionality of the polyether polyols is 1.92 to 3.

15. The aqueous polyurethane urea dispersion according to claim 13, wherein the at least one polyether polyol B) comprises a homo-polyaddition product of propylene oxide having a molecular weight of from 750 to 1250 Da and a functionality of from 1.95 to 2.05.

16. A process for the production of the aqueous polyurethane urea dispersions according to claim 13, comprising
initially charging components A), B), C) and D) into a reactor in full or in part in order to produce a polyurethane prepolymer and optionally diluting with a water-miscible solvent which is inert in respect of isocyanate groups,
heating to a temperature in the range of from 50 to 120° C., and
metering in any of components A), B), C) or D) which were not added at the beginning of the reaction
neutralising with a suitable neutralising agent before or during the dispersing and
optionally distilling off the solvent.

17. The process according to claim 16, wherein, during the production of the prepolymer, the quantities of the individual components A) to D) used are calculated such that an isocyanate index of from 1.05 to 3.0 results.

18. The process according to claim 16, wherein the isocyanate content of the prepolymers is from 1.0 to 9.0%.

19. A coating for flat materials comprising the aqueous polyurethane urea dispersion according to claim 13.

20. An adhesive comprising the aqueous polyurethane urea dispersion according to claim 13.

21. An adhesive composite comprising one or more substrate(s), which may be the same or different, and an adhesive layer comprising the polyurethane urea dispersion according to claim 13.

22. The adhesive composite according to claim 21, wherein the adhesive composite comprises one or more substrate(s) selected from the group consisting of glass fibre, carbon fibre and mineral fibre cloths, an adhesive layer comprising the polyurethane urea dispersions, and a mineral substrate.

23. The adhesive composite according to claim 21, wherein the adhesive composite comprises two wood substrates and an adhesive layer comprising the polyurethane urea dispersion.

24. The adhesive composite according to claim 21, wherein the adhesive composite comprises cork granules bonded with a polymer material, a cork disc, and an adhesive layer comprising the polyurethane urea dispersion.
